(19) United States
(12) Patent Application Publication
(10) Pub. No.: US 2004/0144004 A1
(43) Pub. Date: Jul. 29, 2004

(54) Ear tag for animal identification

(76) Inventor: Anne Constatini, Bretagni (FR)

Correspondence Address: Blakely Sokoloff, Taylor & Zafman, Seventh Floor, 12400 Wilshire Boulevard, Los Angeles, CA, 90025-1026, US

(21) Appl. No.: 10/474,135

(22) PCT Filed: Apr. 9, 2002
(86) PCT No.: PCT/FR02/01221

(30) Foreign Application Priority Data
Apr. 10, 2001 (FR) 01/04838

(51) Int. Cl. G09F 3/00

(52) U.S. Cl. 40/301; 119/850

(57) ABSTRACT

The invention concerns an ear tag (1) for identifying animals, comprising at least a flexible planar wall (2) made of coloured aromatic polyurethane, on one of the large surfaces whereof is affixed a marking in the form of a sign and/or of alphanumeric character and/or of bar code. To prevent degradation by external agents one of the large surfaces at least of the planar wall (2) is coated with a layer of protective material (3) forming for example a screen against UV radiation and a barrier against chemical attacks of certain corrosive agents present in the environment. Said protective layer is made of aliphatic polyurethane.

The present invention has as its object an ear tag protected from the effects of external elements, in particular UV rays, and the chemical action of certain products used in agriculture, such as pesticides. Said tag is intended to be affixed to the ear of the animal to be identified.

The identification of bred animals and in particular cattle, sheep, pigs and goats, is obligatory in many countries to provide a means of health tracking. Said identification, carried out by marking, relates to the animal itself and may also relate to its biological and geographical origin, as well as the place it was bred, the herd of origin and, possibly, the breeder. Said marking may take several forms, for example one or several inscriptions etched into or printed on the tag, taking the form of signs, strings of alphanumeric characters or bar codes. The marking may also be carried Out in one or several colours.

The colour of the tag is another important identifying element. Thus, the tags are yellow or salmon pink and may be green, orange etc.

The ear tags may also be used for marking wild fauna. The colour of the tag may then serve as a means of identifying the sex of the animal, its origin etc. The tag may also comprise several colours, each one relating to a piece of biological data, such as the age, sex, or identity etc of the animal and/or geographical data such as place of birth or of marking etc.

These ear tags consist of aromatic polyurethane, coloured in the mass. Said material is used mainly because of its low cost, as well as its flexibility and resistance to hydrolysis and micro-organisms and its good mechanical resistance, in particular its resistance to tearing and abrasion.

Regardless of the type of use envisaged, it must be possible to make out the colour or colours of the tag, as well as the inscriptions, both from close up and from a distance. However, aromatic polyurethane presents the disadvantage of being sensitive to external agents, and most especially to UV rays. The action of said rays causes deterioration of the colour of the plastic, colour merging as a result of yellowing followed by browning and a substantial reduction in the legibility of the inscriptions.

The action of UV radiation on polyurethane also causes a marked deterioration in the mechanical properties of the tag, so that over time and most notably, said tag loses its flexibility and its resistance to abrasion and tearing.

Moreover, although aromatic polyurethane generally offers good resistance to chemical agents, in some cases certain chemical agents such as pesticides may cause the marking on the tag to deteriorate and thus decrease its legibility.

When a herd is to be marked, the breeder may be compelled to replace discoloured or illegible tags, or tags whose mechanical properties have deteriorated. Preferentially no deterioration of the tag should be discernable for about ten years, which is not always the case at present.

No tag-replacement operation can be carried out in the case of wild fauna, and some of the data necessary for studying the development of this animal population becomes lost.

Despite this problem, which has been clearly identified and recognised for many years, no effective solution has been put forward to avoid the degradation of identification tags by external agents, in particular their discoloration or the loss of markings and information. The only known solution at present is to introduce certain additives into the aromatic polyurethane, but this widely practised solution has been shown to be inadequate. Furthermore, too strong a concentration of anti-UV additives may slightly modify the characteristics of the aromatic polyurethane.

It is an object of the present invention to resolve the aforementioned problem by providing a tag, essentially of aromatic polyurethane, capable of resisting the action of external agents and in particular the discolouring action of UV rays.

A further object of the present invention is to resolve the problem of the degradation of mechanical properties under the effect of the action of UV radiation.

A further object of the present invention is to resolve the problem of the deterioration of the marking caused by corrosive agents contained in certain pesticides or other products that may come into contact with the tag.

To this effect, the ear tag according to the invention, comprising at least one flexible planar wall made of aromatic polyurethane coloured in the mass, or surface coloured, on one of the large surfaces whereof is affixed a marking in the form of a sign and/or of alphanumeric characters and/or of bar codes, is essentially characterised in that at least one of the large surfaces of the planar wall is coated with a layer of material protecting it against external agents and forming a screen notably against UV radiation and a barrier against chemical attacks of certain corrosive agents present in the environment in which the animal wearing the tag is to develop.

Thanks to this feature, there is no longer any risk of discoloration of the coated surface.

In order that the colour of the coated surface should be easily visible, with no degradation, the invention provides for a protective layer that is transparent to visible radiation.

In another aspect of the invention, the protective layer is affixed to at least the two large surfaces of the tag.

In another aspect of the invention, the surface of the tag coated with the protective layer is also the one marked with ink.

In this way the marking is trapped between the protective layer and the layer of aromatic polyurethane.

In another aspect of the invention, the marking is not carried out on the aromatic polyurethane wall but on the protective layer, in particular on the surface of said protective layer intended to come into contact with the tag.

In this way the risk of degradation of the marking by chemical attack is very considerably reduced.

In another aspect of the invention, the said layer of protective material comprises aliphatic polyurethane.

This material presents numerous advantages. Firstly, by forming a protective layer on the tag, abrasion resistance is increased, but above all, by absorbing UV rays it protects the tag from the oxidising action of said rays and thus from yellowing and browning and thus from any loss of legibility of the information carried by the tag. Moreover, it protects the tag very effectively against the deterioration of its mechanical properties so that the tag will keep over time all its properties of resistance to abrasion, tearing, shearing etc, and all its properties of flexibility and elasticity.

Thus, by using a particularly simple means, and one which is inexpensive when the advantages gained are taken into consideration, all the problems linked to the action of UV rays on aromatic polyurethane and on the marking and all the problems linked to the action of chemical agents present in the environment are resolved simultaneously.

There is now no need to introduce specific additives into the aromatic polyurethane to ensure protection against UV rays, thus manufacturing costs are reduced.

In another aspect of the invention, the aliphatic polyurethane layer is some ten hundredths of a millimetre in thickness.

Other advantages and features of the invention will be evident on reading the description of a preferred embodiment given as a non-limiting example, with reference to the attached drawings in which:

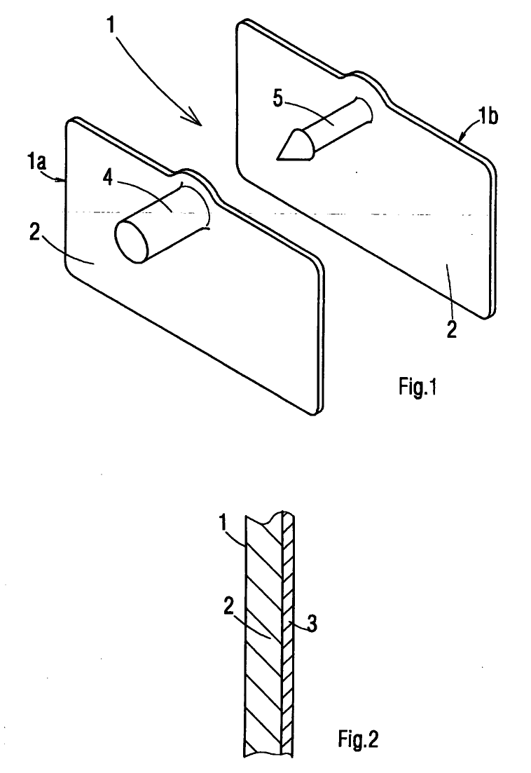

FIG. 1 represents a three-dimensional tag according to the invention;

FIG. 2 is a cross section of one of the planar walls.

As represented, the ear tag 1 according to the invention consists of two parts 1a, 1b, each intended to fit into the other through the ear of the animal to be marked, or through any other suitable part of the animal's body, these two parts of the tag each comprising a flexible planar wall 2, on one of the large surfaces whereof is arranged, in the case of one part, a female element 4 in the form of a head with a receptacle that may be blind and, in the case of the other part, a male element 5 in the form of a pin with a frustoconical end intended to be inserted into the receptacle in the head after having pierced through the ear of the animal to be marked. The receptacle comprises means of locking the frustoconical end in place. Said means prevent the withdrawal of the pin, ensuring that the tag remains in place. Identification marking is carried out on one of the two surfaces of one or both planar walls 1a, 1b.

In a typical embodiment, each planar wall consists of aromatic polyurethane, coloured in the mass. In order to protect said wall, or at least one of the large surfaces, said surface is coated with a layer of protective material 3, forming a screen against UV radiation. Advantageously, the protective layer 3 covers the large surface of the wall to be marked and thus ensures effective protection against the chemical action of corrosive agents found in certain products, for example pesticides.

The protective layer may also be affixed to the two large surfaces and if necessary also to the lateral edges of the planar wall.

Said layer is transparent to visible radiation so that the colour and the marking may be visible.

Preferably the protective layer is capable of absorbing UV radiation.

In a first embodiment, the layer of protective material consists of aliphatic polyurethane, to which constituents may be added, giving increased protection against external agents. Said material ensures particularly effective protection, notably against UV rays, and prevents degradation of colouring and marking and effectively prevents the ageing of the tag and the deterioration of its mechanical properties. Said protective layer comes in the form of a sheet.

Preferentially the thickness of the aliphatic polyurethane layer falls between 50 and 100 μm and is preferably of the order of 75 micrometres.

In a first embodiment, the protective layer is affixed to the corresponding surface of the tag by heat fusing. This technique ensures a close bond between the protective layer and the planar wall. The quality of this bond is reinforced by the fact that the chemical nature of the components of the two materials (aromatic polyurethane and aromatic polyurethane [sic]) is very similar.

In a second embodiment, the protective layer is glued to the corresponding surface.

The two aforementioned bonding techniques can be applied to the protection of a tag that has already been fabricated, the protective layer being cut from a sheet of aliphatic polyurethane and then bonded to the planar wall.

The marking of the planar wall may be performed before or after affixing the protective sheet 3.

The marking can be carried out on the planar wall, but in one variation it may be carried out on the protective layer and on the surface of the said protective layer that is intended to come into contact with the planar wall 2.

In another embodiment, the protective layer (3) is first inserted into a cavity into which the molten material (aromatic polyurethane) of the coloured tag is injected.

In one variation, the protective layer 3 is formed by the injection of molten aliphatic polyurethane into a mould containing the flexible wall and more precisely into a cavity in this mould bounded on one side by the surface of the wall to be coated with the protective layer.

In yet another embodiment, the flexible planar wall 2 and the protective layer 3 are formed by bi-injection.

In another embodiment, the protective layer consists of a varnish that may have a base of aliphatic polyurethane or of any other product capable of ensuring effective protection against external agents and in particular against UV radiation or chemical products such as pesticides. This varnish may be applied by spraying, tampography or by any other appropriate technique.

It is clear that various adjustments and modifications may be made to the present invention without departing from the scope of the invention as defined by the claims.

1. An ear tag (1) for identifying animals, comprising at least one flexible planar wall (2) made of coloured aromatic polyurethane, on one at least of the large surfaces whereof is affixed a marking in the form of a sign and/or of alphanumeric character and/or of bar codes, characterised in that at least one of the large surfaces of the planar wall (2) is coated with a layer of material (3) protecting it against external agents, said layer comprising, in addition, a screen against UV rays.

2. An ear tag according to claim 1, characterised in that the protective layer forms a barrier against the chemical attacks of certain corrosive agents present in the environment in which the animal wearing the tag is to grow.

3. An ear tag according to claim 1 or claim 2, characterised in that the protective layer (3) is transparent to visible radiation.

4. An ear tag according to any one of the previous claims, characterised in that the protective layer (3) coats the surface of the planar wall (2) to be marked.

5. An ear tag according to any one of the previous claims, characterised in that the layer of protective material (3) is formed essentially of aliphatic polyurethane.

6. An ear tag according to any one of claims 1 to 4, characterised in that the layer of protective material (3) is formed exclusively of aliphatic polyurethane.

7. An ear tag according to claim 5 or claim 6, characterised in that the layer of protective material is some ten hundredths of a millimetre in thickness.

8. An ear tag according to any one of the previous claims, characterised in that the protective layer (3) is affixed to the planar wall by heat fusing.

9. An ear tag according to any one of claims 1 to 7, characterised in that the protective layer (3) is glued to the planar wall.

10. An ear tag according to any one of claims 1 to 7, characterised in that the protective layer (3) is first inserted into a cavity into which the molten material of the coloured tag is injected.

11. An ear tag according to any one of claims 1 to 7, characterised in that the flexible planar wall and the protective layer (3) are formed by bi-injection.

12. An ear tag according to any one of claims 1 to 7, characterised in that the protective layer (3) is affixed by tampography.

13. An ear tag according to any one of claims 1 to 7, characterised in that the protective layer is affixed by spraying.

14. An ear tag according to any one of the previous claims, characterised in that the marking is carried out on the planar wall (2).

15. An ear tag according to any one of claims 1 to 13, characterised in that the marking is carried out on the protective layer (3) and on the surface of the latter that is intended to come into contact with the planar wall (2).
